(19) United States
(12) Patent Application Publication
(10) Pub. No.: US 2014/0074671 A1
(43) Pub. Date: Mar. 13, 2014

(54) Computer-Aided System for Improving Return on Assets

(71) Applicants: Ameet Kumar, Dublin, CA (US); Michael Lee Rothschild, Greenbrae, CA (US); Mark Shwert, San Francisco, CA (US); Jake Alan Farmer, Wilmington, NC (US); Gilbert Gee-yin Chan, Hayward, CA (US)

(72) Inventor: MICHAEL LEE ROTHSCHILD, Greenbrae, CA (US)

(73) Assignee: PROFIT VELOCITY SOLUTIONS, LLC, Greenbrae, CA (US)

(21) Appl. No.: 14/022,423

(22) Filed: Sep. 10, 2013

Related U.S. Application Data
(60) Provisional application No. 61/698,729, filed on Sep. 10, 2012.

(51) Int. Cl. G06Q 40/00

(52) U.S. Cl. CPC G06Q 40/12
USPC 705/30

(57) ABSTRACT

Management software for increasing of return on assets (ROA) and, more particularly, to software-enabled systems, methods and apparatus using the metric profit per asset-hour (PPAH) for measuring and increasing profit generated by asset utilization to increase return on assets (ROA) and likewise return on equity (ROE).

### CROSS REFERENCE TO RELATED APPLICATIONS

This patent application claims priority from U.S. provisional patent application Ser. No. 61/698,729, filed Sep. 10, 2012, the entirety of which is incorporated herein by this reference thereto.

### BACKGROUND OF THE INVENTION

1. Technical Field

This invention relates generally to the field of management software for increasing return on equity (ROE) and more particularly to software enabled systems, methods and apparatus for measuring and increasing profit generated by asset utilization to increase return on assets (ROA).

2. Description of the Related Art

Return on equity (ROE) is the highest summary level metric by which the historical financial performance of companies and management teams are judged by investors and the greater financial community. Return on equity measures the rate of growth of the shareholder equity in a business as profit produced in each new time period is added to cumulative past profits and equity investments made in prior times. ROE is the ultimate goal in financial performance, because the higher the ROE ratio, the faster the equity of shareholders is growing, and hence the faster the company's share price tends to rise.

Referring to FIG. 1, the widely taught DuPont™ (“DuPont”) “profit formula” 100 is often used to explain the factors driving ROE. ROE 111 is comprised of three interacting financial ratios: assets/equity (leverage) 112, profit/units (margin) 113, and units/assets (asset turnover) 114 (shown in various algebraic representations (a)-(d). Algebraically, ROE=leverage×margin×turnover, which reveals how effectively a company's management used investors' equity over a past period (typically a year or a quarter).

The leverage ratio (assets per equity) 112 is largely determined by conditions in external financial markets and is not under the direct control of a company's management. Holding leverage to a constant, “f” 122 then, the remaining ratios that management can influence are margin 113 (profit per units) and asset turnover (units per assets) 114. Taken together margin 113×asset turnover 114=ROA 110. Return on assets (ROA) 110 is another summary level financial indicator which tends to be monitored on an annual or semi-annual or quarterly basis. The ROA ratio indicates how effective management's decisions have been in a prior time period in generating profit from all the assets under their control.

The assets arid unit components are reported in aggregate amounts over the entire period reported, which does not afford the information required for an analysis of the past interplay that existed between the various underlying factors that determined each nor a forward looking analysis of how those factors will influence the future performance.

Although ROA is the vital high-level indicator of management's past performance, this backward-looking, historical summary level indicator of financial performance is of minimal usefulness to operating managers and executives who must make detailed, forward-looking, hour-to-hour, day-to-day, month-to-month decisions and plans regarding the most profitable use of assets. In short, improving ROA is a vital goal of managers and executives, but ROA does not serve as a useful metric in business operations.

Instead of relying on the summary level metric of ROA to evaluate options for improving financial performance, managements rely on the detailed measurement of margin (profit per unit). A wide variety of profit analysis and product costing systems, ERP systems, and others calculate margin in great detail. However, controlling margin alone is not sufficient to drive up ROA. Again, ROA=Margin×Asset Turnover (units per assets). To increase ROA, management must be able to proactively manage both Margin and Asset Turnover together in as much detail as possible, for each transaction, order, production batch, customer, etc.

However, until now, no computer-aided system has combined at any level of detail desired, on a forward-looking planning basis, margin and asset turnover data values to report the metric profit per asset-hour (PPAH). Consequently, instead of maximizing what investors actually want, higher ROA (in order to achieve the ultimate goal of higher ROE), management teams have traditionally measured and pursued the improvement of the only useful detailed profit indicator available to them margin. To allow management teams to effectively pursue their shareholders' goal of higher ROA (to yield a higher ROE), management teams need access to a detailed, practical measure of ROA, or margin and asset turnover, or profit per asset-hour. The invention calculates and displays the metric of profit per asset-hour, incorporating both margin 113 and asset turn over 114, at any level of detailed desired, as part of a forward-planning and decision-support environment which allows management teams to pursue the metric their investors actually want, higher ROA in order to achieve higher ROE and faster share price growth.

### SUMMARY OF INVENTION

A primary element of the present invention is a metric that measures the profit produced by an asset over a unit of time (second, minute, hour, etc.). This metric is expressed throughout as “profit per asset-hour hereafter, also “PPAH”).

While the metric of profit per asset-time is expressed with the unit of time being an hour, the invention is not so limited. An hour may, in most cases, be the most incisive or convenient unit of time to use but in any particular case another different unit of time may prove more useful and could be used without departing from the invention as will be obvious from what follows. Thus, “profit per asset-unit of time” should be considered as having the same meaning as “profit per asset-hour” in describing and understanding the invention.

Detailed measurement of the speed at which manufacturing assets deliver profit can advantageously guide management decision-making in accurately anticipating, pursuing, and accepting orders and allocating production capacity against those orders to get those assets to make money faster. PPAH also provides information that helps decision-makers consider different futures where they adjust customer, sales, and manufacturing planning in order to improve asset utilization and capital investment activities for increasing ROA. PPAH, when used as described herein by decision-makers to assess manufacturing, sales, and customer combinations, provides a means to better anticipate results in the future and adjust decision-making pertaining to product mix, customer mix, and asset mix to drive the maximization of ROA.

The software, methods, apparatus and systems of the present invention provide management with powerful insight into what has driven ROA in the past and what are the best decisions moving forward to increase ROA.

More specifically, in one embodiment, the present invention provides software that causes a computer to: extract selected data from one or more non-transitory databases of transactional processing management systems, such as enterprise resource planning systems, production management systems, other legacy systems, open source systems, proprietary systems, or the like; calculate various values from the extracted data including PPAH; and display the calculated results on a digital display device in an interactive format.

The invention departs from known systems by calculating and reporting profit over a selected time period factoring in products, customers, margins, productivity and any number of other variables that have an impact on the metric PPAH. Moreover, the metric PPAH is calculated and reported for individual assets, customers, products, customer-product mix, etc.

Because margin 113 and asset turnover 114 have to be measured and managed jointly to improve ROA 110, such improvement is not necessarily achieved by simply adjusting these variables separately. The adjustment of margin 113 and asset turnover 114 to increase ROA 110 usually involves making tradeoffs increases and/or decreases in component values within the constrained limits of the components to yield improved ROA. Prior to the implementation of the metric PPAH, as made possible by the present invention, margin 113 has been almost universally used as the primary metric for profitability analysis and management. With the present invention providing management access to the new metric of PPAH, far more refined profit analysis and planning is made possible revealing new opportunities for management to increase ROA.

Asset turnover 114 is traditionally measured only on a consolidated level for the various products of the company taken together, over all the assets used on an annual, semi-annual or quarterly basis. Although the data necessary to calculate the PPAH metric, at the hourly level and for each transaction, order, asset, each customer, product, etc., are typically captured by production control systems for the various products made by a company, prior to the present invention this data has not been extracted and processed for each transaction, order, asset, customer, product, etc., and integrated with other available data in a form useful for aiding management in analyzing past performance and making prospective marketing, sales, production, asset investment decisions on an hour-to-hour, day-to-day basis with the continuous improvement of ROA 110 as the goal.

While the present invention has application to all industries, it has the greatest impact on the manufacturing sector where the assets employed (be they natural, man-made, or human) in production are significant. This is especially true for manufacturers who produce a wide variety and volume of products, stock-keeping units (SKUs), for an array of customers, often including multiple production facilities (hereafter, also “High Mix”). In industries such as chemicals, steel, semiconductors, electronic components, packaging, and paper, or the like, a single company may often produce hundreds, if not tens of thousands, of distinct product types and items. While such High Mix product manufacturers attempt to measure and control the unit profit margin of their products, their systems do not enable them to measure and manage PPAH, or the rate of cash contribution or profit flow per hour of asset utilization for a given transaction, order, product, customer, asset or any other variable that contributes to the calculation of ROA 110. Manufacturers are also unable to discern the sensitive and non-linear relationship between margin 113 and asset turnover 114. Profit analysis systems are traditionally based on margin per unit rather than profit per asset-hour (PPAH). Production control (PC) or manufacturing execution systems (MES) measure machine time used and physical unit throughput rates, but lack the integration with cost and financial information required to calculate profit per asset-hour which directly drives ROA 110. With the ability of the present invention to measure, report, and explore the future impact of upcoming business decisions on ROA 110, decision-makers in marketing, sales, production, operations, finance, and all other functional areas of a complex enterprise, have for the first time the ability to analyze, accurately anticipate, plan, and positively influence the rate of cash contribution or profit per asset per hour. The present invention, for the first time, makes it possible for management teams to see and understand precisely—down to the transaction, or sales order level, and the like where trade-off adjustments to prices, costs, productivity, volume, and product mix speed up the overall flow of profits through the assets and thereby improve ROA 110.

### BRIEF DESCRIPTION OF THE DRAWINGS

FIG. 1 is a schematic diagram that depicts algebraically the DuPont' formula for return on investment (ROE) and return on assets (ROA), expressed in various algebraic notations (a)-(e) according to the prior art;

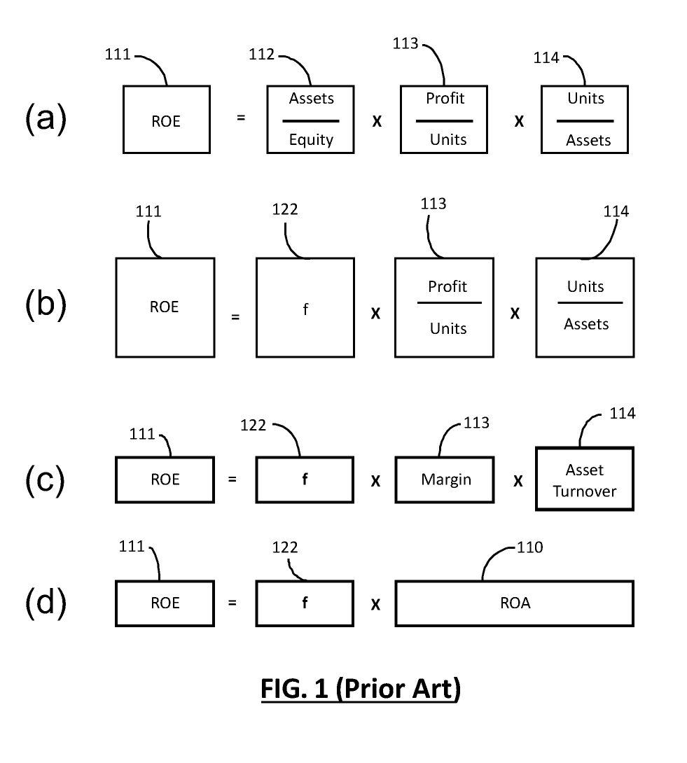

FIG. 2 is a schematic diagram that depicts the formula for profit per asset hour (PPAH) according to the present invention and as useful for individual assets, products, customers etc.;

FIG. 3 is a flowchart of the PPAH system of an embodiment of the invention including process steps and components;

FIG. 4 is a block diagram of the integrated profit per asset-hour planning system, (PPAHPS) according to an embodiment of the invention;

FIG. 5 is a graph depicting an example of a way to chart PPAH for profit maximization, according to an embodiment of the invention;

FIG. 6 is a block schematic diagram of a system in the exemplary form of a computer system according to an embodiment; and

FIG. 7 is an exemplary PPAH formatted dataset.

### DETAILED DESCRIPTION OF THE INVENTION

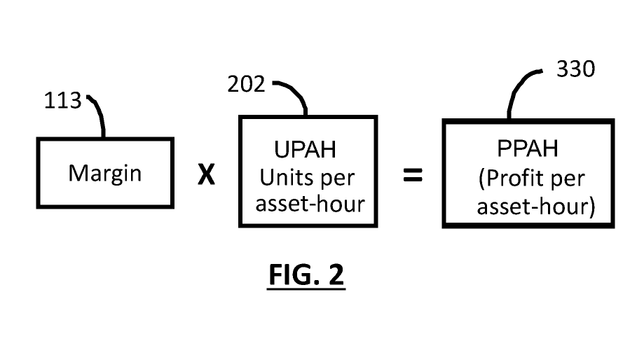

Referring also to FIG. 2, a new metric—Profit Per Asset-Hour (PPAH) 330, according to the present invention, is the metric of margin 113 multiplied by units per asset hour (UPAH) 202. Using this metric, as described below, allows the performance character of manufacturing assets to be matched to the specific products they produce, including the product margin returned by the asset over time, by product, by customer, by order, or raw material used, and any other known factor that impacts or influences the metric PPAH.

PPAH 330 also provides a basis for improving ROA 110 and hence ROE 101. By extracting and aggregating the output units from the assets for a specified period of time, such as a minute, an hour, or any other measurable time unit, based on the type of products manufactured, and knowing the margin 113 of the products manufactured, PPAH 330 can be anticipated, calculated, evaluated, and adjusted to produce increases in financial returns.

In a typical High Mix manufacturing company, the necessary data for calculating PPAH 330 is available unsystematically in the company's databases. These databases include, but are not limited to, the databases underlying transactional processing management systems (TPM Systems) including without limitation: enterprise resource planning systems (ERP), financial reporting systems (FRS), inventory and invoicing systems (IIS), marketing systems (MS), production control (PC), and manufacturing execution systems (MES). Collectively, these and like legacy systems are hereinafter referred to as “TPM Systems”.

Useful transaction-level data and information that can be extracted from a company's existing TPM Systems may include but are not limited to: costs such as cost of material and direct labor cost for each product made, as well as indirect costs such as depreciation of equipment and other overheads allocated to individual products. Similarly, other important data that can be extracted includes but are not limited to: pricing details, volume incentives and promotions provided to customers, sales targets, sales forecasts inventory costs invoicing details from asset utilization, asset scheduling details, and production throughput rates.

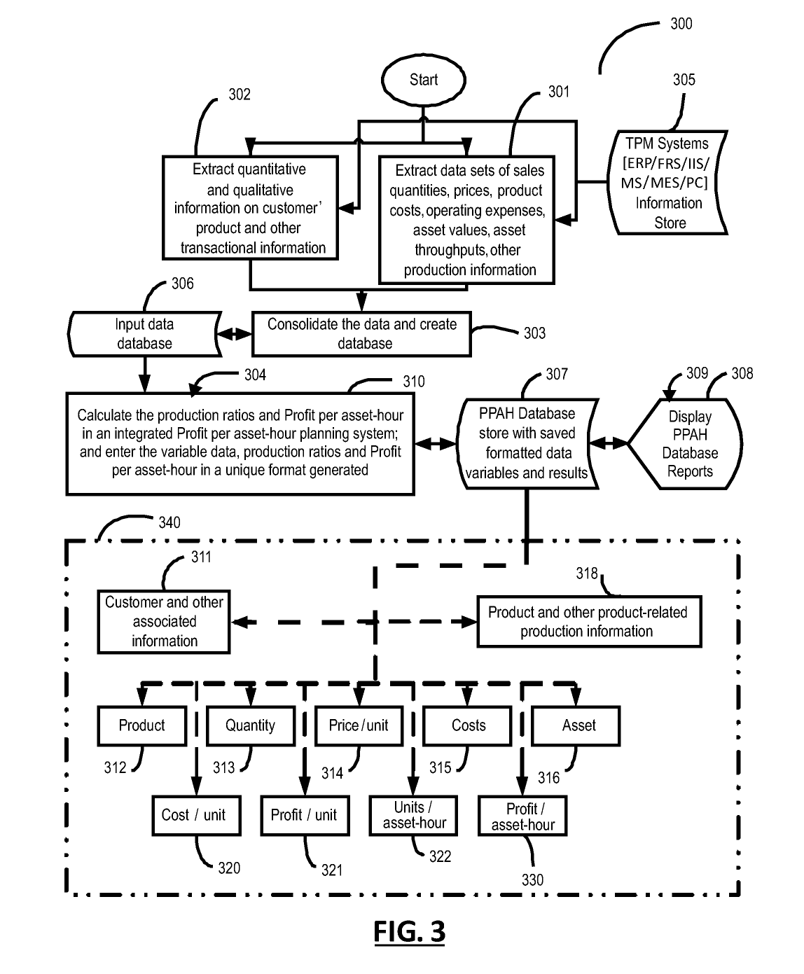

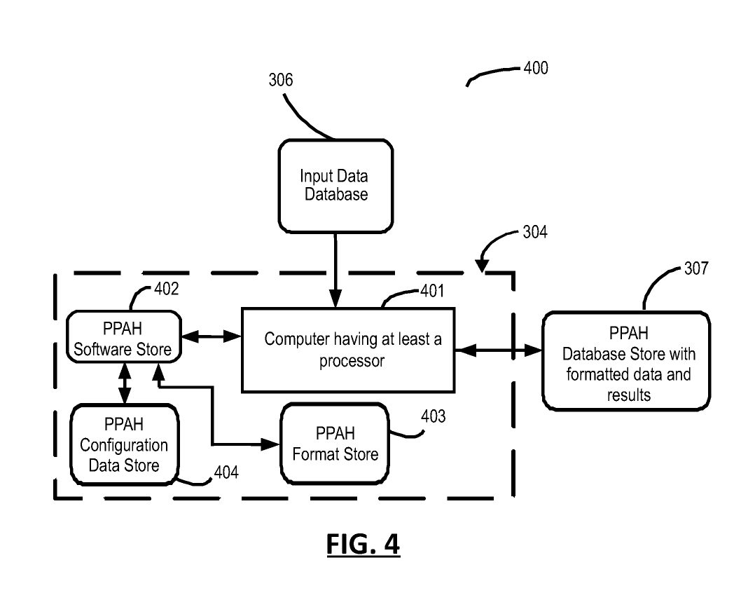

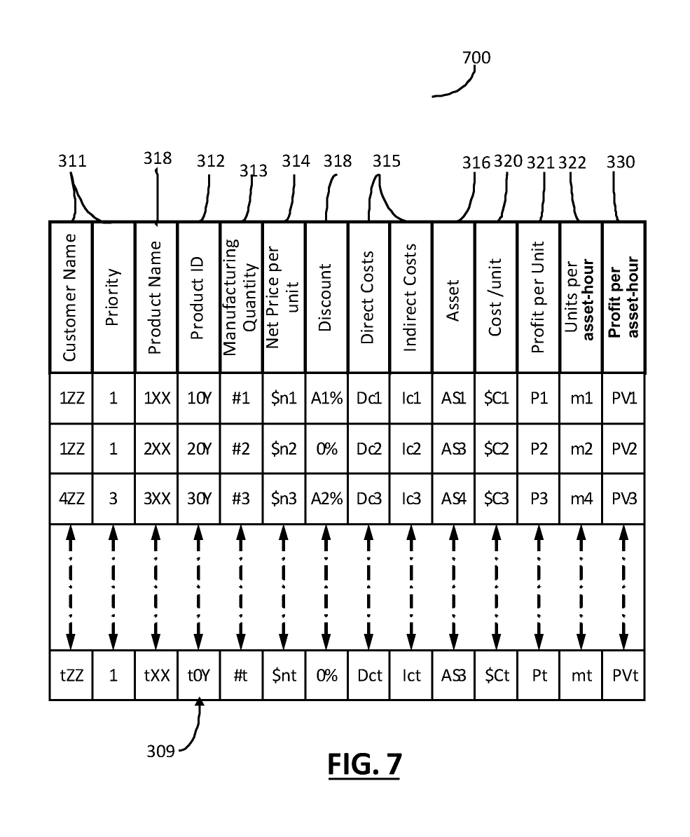

Referring to FIG. 3, a computer implemented system 300, having sufficient processing power and storage capability, with a minimum of components, of the present invention generates a PPAH database 307 of saved formatted data variables and calculated results (data set) shown in expanded detail at 340. Collected data 305 from a company's TPM System, such as, for example, data on products sold 312, sales volumes (quantity) 313, price per unit 314, costs (of product) 315 (including direct and indirect costs), and asset 316 used in manufacturing of each product, is extracted by method step 301 and consolidated by method step 303 and stored in database 306 (referred to hereafter as “Input Data” database 306). Additional qualitative information on customers 311 and products 318 that may be needed to optimize customer and product mix also may be extracted 302 from TPM Systems 305, consolidated 303 and stored in Input Data database 306. In addition, some transactional information such as, but not limited to, seasonal material cost variations, changing prices, changing product volumes, that may impact profit per asset-hour 330 are also extracted 302 from TPM Systems 305, consolidated 303 and stored in Input Data database 306. The collected information in Input Data database 306 is used by PPAH integrated planning system (PPAHPS) 304 (described in greater detail below in connection with FIG. 4) to make the calculations by method step 310 of the key financial and operational ratios such as but not limited to cost per unit 320, profit per unit 321, and units per asset-hour 322, enabling the computation of a PPAH 330 for each transaction, order, product, asset, customer, etc. The formatted data variables from Input Data database 306 and computed key financial and operational ratios 314, 320, 321, 322 (hereafter also referred to collectively as “F&O ratios”) and computed PPAH 330, are stored in the PPAH Database Store 307 from which they can be displayed by method step 308 in a useful interactive format on a display device 309 (such as that illustrated in FIG. 7).

The saved, formatted data variables in PPAH Database Store 307 can be changed, as described more fully below, in which case the F&O ratios and PPAH 330 are recalculated and stored in database 307 from which they can be displayed by method step 308.

Referring to FIGS. 3, 4 and 7, PPAHPS 304 (FIG. 3) implemented on a computer system with peripheral storage systems Input Data database 306 and PPAH Database Store 307. PPAHPS 304 comprises a computer 401, having at least one processor for handling the data processing needs, a PPAH Configuration Data Store 404 containing business process flow and data transformational rules and a PPAH software store 402 that stores software that, when implemented by computer 401, causes the computer 401 to, among other things, read, integrate, and format data from Input Data database 306 and calculate the F&O ratios and PPAH 330 all of which (including the 340 dataset by which the ratios are calculated) are stored in PPAH Database Store 307 in a PPAH format from PPAH Format Store 403, such as the format of PPAH formatted data-set 700 shown in FIG. 7 and described below. This PPAH format enables the computation of PPAH 330 from the various input data elements and data variables in PPAH Database Store 307 without additional database searches.

Transformation rules of PPAH Configuration Data Store 404 enable software from PPAH Software store 402 to cause the computer 401 to calculate the F&O ratios and PPAH 330 using data from existing data stores such as TPM Systems and the like, or manually entering input data, or any combination thereof representing a subset of input data expressing transformational instructions, such as the actual of estimated PPAH for a customer, market segment, or product group during various time ranges, or other highly complex transformation schemes. Such transformational rules define a manner of collecting, organizing, and integrating the different input data elements to enable computer 401 to calculate the F&O ratios and PPAH 330 under various forecasted or planned circumstances, requests, and other influences, and the like.

In operation, data elements for computing the F&O ratios and PPAH 330 are provided to the PPAH Format used by PPAHPS 304 from the Input Data database 306. The data variables from Input Data database 306 are used to populate the PPAH format 700. Computer 401 then runs the PPAHPS 304 a software program from PPAH Software Store 402 on the input data variables to compute the profit ratios, 320 to 322 (F&O ratios) and PPAH 330. The results are input to the PPAH format to generate the PPAH formatted dataset 700 similar to the exemplary format shown in FIG. 7. This resulting dataset 340, formatted as shown in an exemplary format 700 (FIG. 7) is stored in PPAH Database Store 307, where it is accessible to and useful for decision-makers.

PPAH Format Store 403, PPAH Configuration Store 404, and PPAH Software Store 402 interact with each other and data from Input Data database 306 whereby computer 401 performs the 310 method step of calculating the F&O ratios and PPAH 330, and displaying the data and calculated ratios on display device 309 in a format such as that shown in the example of FIG. 7 in a manner well known to those skilled in the art.

The interactive PPAH formatted dataset 700 enables values of individual cells to be changed (in a “what if” analysis) causing the computer 401 to recalculate the data, which in most cases will cause the displayed values in other cells to change to the accurately recalculated values.

The typical variables that may be modified, via manual intervention, for accurately anticipating and forecasting detailed scenarios include, but are not limited to, sales quantities and prices, product costs, business operating expenses, production times and capacity information, and business asset values. Additional quantitative and qualitative information reflecting customer purchases, product volumes, and other transactional information that impact business operations may also be linked to the data inputs within the PPAH formatted dataset 700 to enable decision-makers to understand the factors driving the PPAH of particular transactions, orders, products, customers, and assets.

Thus, the invention enables decision-makers to simulate and forecast various detailed external (marketplace) and internal (workplace) scenarios by modifying any of several data inputs in the integrated PPAH formatted dataset 700 which when recalculated by method step 310 accurately predicts the financial profit-making impact of current and future conditions and decisions.

PPAHPS 304 provides the decision-maker with the capability to vary each data input element in the PPAH formatted dataset 700, individually and as a group within the PPAHPS 304 and simulate for the resultant PPAH 330 value. The results of these simulations enable decision-maker to make better informed decisions on the impact these decisions will have on future detailed PPAH 330 and overall ROA. The decision-makers are able to get a more accurate view of the impact on profitability by correctly anticipating results and observing the outcomes of changes to one or more variables, using PPAHPS 304, as the various data elements are uniquely interdependent and integrated.

Some business choices that must be optimized in a multi-product company may include but are not limited to: 1) What product mix should decision-makers give greater influence?; 2) Which customers, according to profit contribution, should be given greater priority?; and, 3) How can decision-makers improve profit within the confines of current capacity utilization, including capital expenditure planning related to expansion, or the reduction of physical production capacity through the elimination of facilities. The scenario modeling activity leading to answers to these questions is provided readily by use of PPAHPS 304 in accordance with embodiments of the invention described herein.

In accordance with an embodiment of the invention, advantages of PPAHPS 304, in addition to the capability of extracting profit results, include enabling the user to have control over the following:
Ability to integrate various sources of data into PPAHPS 304, based on the PPAH metric. Typical prior art forecasts include quantity requirement projections and price with no related costs data associated with each of the specific products manufactured and without production run time data at key production steps. PPAHPS 304 selective input functionality enables the decision-maker to determine and configure in PPAHPS 304 a criteria enabling search and automatic input for calculating forecast results with the heretofor missing data such as costs and production flow rates. Due to this ability of PPAHPS 304 to look-up, calculate, and selectively input detailed cost and production flow rate modifications or additions to each line item, the user is able to calculate the profitability of their forecast line items results by PPAH 330 and assess their ranking PPAH.
PPAHPS 304 provides information and data that enables decision-makers to anticipate future ROA accurately by providing the ability to simulate and/or forecast various scenarios, but is not limited to such scenarios: PPAHPS 304 allows decision-makers to modify any one or several data input elements or data variables that may impact the profitability of any forecast, such as but not limited to quantity, price, cost, production flow rate, and equipment capacity changes. PPAHPS 304 gives the decision-maker the unique ability to accurately anticipate, modify, and adjust future influential events and their data parameters and see the impact of various combinations of potential events to determine which event(s) and likely results increase ROA thereby providing the decision-makers the opportunity to achieve the profit improvement results which the PPAHPS 304 uniquely makes available.
PPAHPS 304 allows the decision-maker to make adjustments or edits to the input data elements or data variables at any level of aggregation/disaggregation with the capability of assessing the impact of those adjustments across available and pending sales orders ranked by PPAH. This assessment of impact provides decision-makers the opportunity to change the parameters of incoming sales orders in order to improve the profitability of the assets.

It will be obvious to those skilled in the art that not all possible sets of components of PPAH 330 are shown in the exemplary data-set 700. The exemplary sets of components 700 that are shown provide an understanding of the invention and detail of extraction and compilation of PPAH information using the invention in accordance with an embodiment.

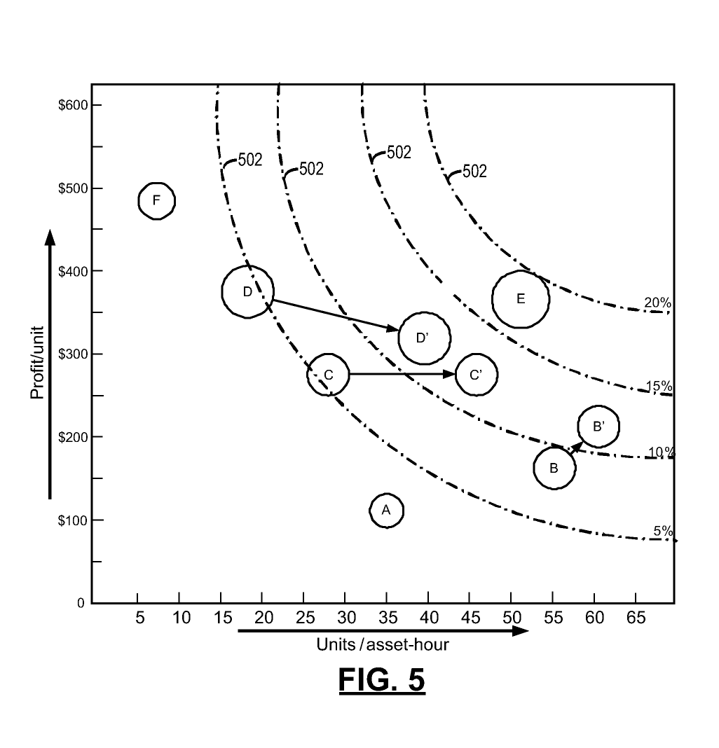

Referring to FIG. 5, is an exemplary and non-limiting graph locates a plurality of products A-F of a company's manufacturing line relative to their individual PPAH 330. The left vertical axis represents profit per unit (margin) 113 and the lower horizontal axis represents units per asset-hour 202. The components of profit per asset-hour 330 for any given product are the two coordinates that locate the product on the graph. Each broken-line contour curve 502 represents all combinations of profit/unit and units per asset-hour that equal one value of profit-per-asset-hour 330. Each of these contour curves 502 and profit per asset-hour values also reflect an ROA% based on the value of the asset base applicable to that set of data depicted in the chart and calculated using the transformational rules. The broken-line contour curves 502 are a plot of aggregate ROA levels expressed as a percent. By plotting the PPAH of a product it can be immediately seen if that product will meet a ROA target set by the company. For the different products A-F shown, the invention provides decision-makers the ability to understand and adjust the component variables which describe the character of the associated products, orders, manufacturing assets, prices, and the like, which influence their financial return generated, ROA. For example, products A, B, and F display a profit per asset-hour ratio that does not represent achieving, for example, a 10% targeted ROA, inasmuch as they reside below the 10% ROA threshold curve 502.

However, under traditional unit and margin analysis, decision-makers would errantly perceive these products as more significant contributors to ROA, because they either display significant unit margin (F) or unit velocity (A and B). Products A and B, by example, present significant unit velocity, but lower unit margin, while products C, D, and F, by example, present higher unit margin but lower unit velocity. Unless decision-makers have integrated and combined access to margin 113 and UPAH 202, trade-off sensitivities (position relative to a curve 502) for each product they will be unable to accurately anticipate the results of different potential futures, make decisions, and take initiatives to move products, orders, and customers toward higher levels of ROA, as depicted by the combination higher margin and UPAH products, in the case of product E, which resides above the 15% ROA curve. Products B, C, and D are shown as having alternate positions B′, C′, and D′ (all above the 10% curve) to illustrate the possibility of moving these products into a higher ROA level by modifying one or more of the variables (see FIG. 7) that determine their PPAH 330.

A person skilled in the art would readily appreciate that the invention disclosed herein is described with respect to specific embodiments that are exemplary. However, this should not be considered a limitation on the scope of the invention. Specifically, other implementations of the disclosed invention are envisioned and hence the invention should not be considered to be limited to the specific embodiments discussed herein above. Embodiments may be implemented on other computing capable systems and processors or a combination of the above. Embodiments may also be implemented as a software program stored in a memory module, to be run on an embedded, standalone or distributed processor, or processing system. Embodiments may also be run on a processor, a combination of integrated software and hardware, or as emulation on hardware on a server, a desktop, or a mobile computing device. The invention should not be considered as being limited in scope based on specific implementation details, but should be considered on the basis of current and future envisioned implementation capabilities.

### An Additional Example Machine Overview

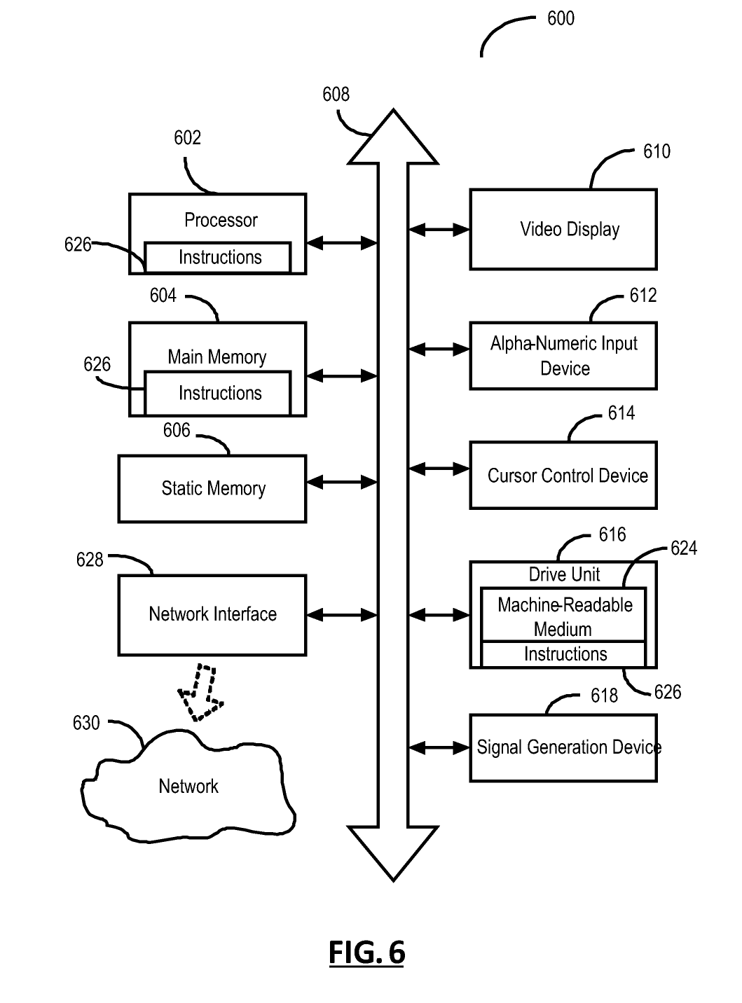

FIG. 6 is a block schematic diagram of a system in the exemplary form of a computer system 600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance, or any system capable of executing a sequence of instructions that specify actions to be taken by that system.

The computer system 600 includes a processor 602, a main memory 604, and a static memory 606, which communicate with each other via a bus 608. The computer system 600 may further include a display unit 610, for example, a liquid crystal display (LCD). The computer system 600 also includes an alphanumeric input device 612, for example, a keyboard; a cursor control device 614, for example, a mouse; a disk drive unit 616; a signal generation device 618, for example, a speaker; and a network interface device 628.

The disk drive unit 616 includes a machine-readable medium 624 on which is stored a set of executable instructions, i.e. software, 626 embodying any one, or all, of the methodologies described herein below. The software 626 is also shown to reside, completely or at least partially, within the main memory 604 and/or within the processor 602. The software 626 may further be transmitted or received over a network 630 by means of a network interface device 628.

In contrast to the system 600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine-readable medium includes read-only memory (ROM); random-access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users to obtain a profit improvement using a metric of profit per asset hour for improving return on assets (ROA) on such internet-enabled or other network-enabled devices, servers, or clients. It further should be appreciated that one or more cloud computing embodiments may include providing a profit improvement using a metric of profit per asset hour for improving return on assets (ROA) using mobile devices, tablets, and the like, as such devices are becoming standard consumer devices.

Although the invention is described herein with reference to the preferred embodiment, one skilled in the art may readily appreciate that other applications may be substituted for those set forth herein without departing from the spirit and scope of the present invention. Accordingly, the invention should only be limited by the claims included below.

What is claimed is:

1. A computer aided system for improving ROA and calculating and presenting a graphic representation of a profit per asset-hour (PPAH) metric, for a company manufacturing a plurality of different products using assets and having a plurality of TPM System databases comprising:
an Input Data database containing selected data from TPM System databases;
a processor disposed to receive a dataset from said Input Data database;
a Software Store operatively disposed with respect to said processor containing instructions which when executed by said processor generates a plurality of calculated results based on the dataset from said Input Data database comprising: manufacturing ratios, profit ratios, and the metric profit per asset-hour (PPAH);
a PPAH database operatively disposed with respect to said processor for storing the calculated results and the dataset from Input Data database used in generating the calculated results; and
a digital display device operatively disposed with respect to said PPAH database for displaying data in said PPAH database.

2. The system of claim 1, wherein the data from TPM Systems databases comprise any of: information on products sold, sales volumes, price of products, cost of product comprising direct and indirect costs, assets used in manufacturing each product, quantitative information on customers and products, seasonal material cost variations, overtime payment details.

3. The system of claim 1, wherein manufacturing ratios and profit ratios comprise any of: cost per unit, profit per unit, and units per asset-hour.

4. The system of claim 1, wherein data from the PPAH database displayed on said display device is a graph on which the PPAH of products is located relative to ROA.

5. The system of claim 4, wherein: the vertical axis of the graph is profit per unit and the horizontal axis of the graph is units per asset-hour and ROA is presented as a set of curves.

6. The system of claim 1, wherein the data from the PPAH database displayed on said display device is in the form of a chart comprising cells in columns and rows.

7. The system of claim 6, further configured to permit manually changing the values in any of the chart cells wherein said processor recalculates the cell values thereby providing simulation capability for increasing ROA by predicting and planning for an optimum product mix, customer mix, and asset mix using ROA criteria.

8. The system of claim 1, wherein the PPAH is computed for each product for product mix optimization.

9. A method implemented on a profit per asset-hour planning system (PPAHPS), comprising processing and storage units, for increasing return on assets (ROA) for a company producing a plurality of different products with assets and having TMP databases, the method comprising:
extracting from data stored in TMP databases, datasets of variable data, said variable data comprising any of sales quantities, prices, product costs, operating expenses, asset values, asset throughputs, and other production information;
extracting, from said TPM System, information on customers and products and transitional information comprising any of seasonal raw-material cost changes, periodic demand increases, and competitive price variations;
compiling and consolidating the extracted data and information;
populating an Input Data database with compiled and consolidated data and information for use in generating profit ratios and a profit per asset-hour (PPAH) metric;
generating profit ratios and PPAH using the compiled and consolidated data and information from the Input Data database;
populating and storing in a PPAH database the generated profit ratios, generated PPAH, any of said extracted data and information, and any of said compiled and consolidated extracted data and information, said stored data for use by an end user; and
allowing an end user to change any of the data stored in the PPAH database to generate estimates of profitability and to use said generated estimates of profitability to plan for increasing ROA.

10. The method of claim 10, wherein TPM System databases comprise data stored by any of ERP systems, financial reporting systems, inventory and invoicing systems, marketing systems, manufacturing execution systems, and production control systems.

11. The method of claim 10, wherein data from the Input Data database is used to compute financial and operational ratios.

12. The method of claim 10, further comprising allowing an end user to assess and test how changing any of said data stored in said PPAH database impacts at least one PPAH of at least one product.

13. The method of claim 10, wherein PPAH is computed for each different product for product contribution to ROA and analysis and product mix optimization.

14. The method of claim 10, further comprising:
using generated estimates of profitability in simulation for predicting and planning an optimum product mix and customer mix and asset purchases for maximum profit.

15. A machine readable storage medium having stored thereon a computer program for generating quantitative production variables including profit per asset-hour (PPAH) as a guide to increase return on assets (ROE) for a company using assets to produce a plurality of different products, the computer program comprising a routine of set instructions for causing the machine to perform the steps of:
extracting selected data from one or more non-transitory TPM System databases;
calculating various production variables from the extracted TPM System databases including profit per asset-hour (PPAH);
displaying calculated results on a digital display device.

16. The machine readable storage medium of claim 1, wherein the machine performs the step of:
storing extracted selected data and calculated results in a non-transitory database; and
wherein the displayed calculated results further include extracted selected data which together with calculated results are displayed in an interactive format whereby one or more selected data or calculated results can be changed and new results calculated.

17. The machine readable storage medium of claim 1, wherein the machine performs the step of:
storing extracted selected data and calculated results in a non-transitory database; and
wherein the displayed calculated results is a graph on which the PPAH of individual products is located relative to ROA.
